(19) United States
(12) Patent Application Publication
(10) Pub. No.: US 2025/0162456 A1
(43) Pub. Date: May 22, 2025

(54) BATTERY SYSTEM OF ELECTRIC VEHICLE AND METHOD OF CONTROLLING THE SAME DURING CHARGING

(71) Applicants: HYUNDAI MOTOR COMPANY, Seoul (KR); Kia Corporation, Seoul (KR)

(72) Inventor: Jung Hyun Lee, Whasung-si (KR)

(73) Assignees: HYUNDAI MOTOR COMPANY, Seoul (KR); Kia Corporation, Seoul (KR)

(21) Appl. No.: 19/025,191

(22) Filed: Jan. 16, 2025

Related U.S. Application Data
(63) Continuation-in-part of application No. 18/101,278, filed on Jan. 25, 2023.

(30) Foreign Application Priority Data
Sep. 27, 2022 (KR) 10-2022-0122441

(51) Int. Cl. B60L 58/19; B60L 53/63; B60L 58/12

(52) U.S. Cl. CPC B60L 58/19; B60L 53/63; B60L 58/12; B60L 2240/547

(57) ABSTRACT

A battery system of an electric vehicle includes a first group module configured by connecting a plurality of battery modules in series, a second group module configured by connecting a plurality of battery modules in series, a voltage switching circuit unit configured between the first group module and the second group module to switch and vary a circuit connection state between the first group module and the second group module between a series connection state and a parallel connection state, and a controller configured to control an operation of the voltage switching circuit unit based on information of a charger connected to the vehicle and battery state information when a battery of the vehicle is charged.

### CROSS-REFERENCE TO RELATED APPLICATION

The present application claims priority to Korean Patent Application No. 10-2022-0122441 filed on Sep. 27, 2022, the disclosures of which applications are incorporated by reference herein.

### BACKGROUND OF THE PRESENT DISCLOSURE

### Field of the Present Disclosure

The present disclosure relates to a battery system and a method of controlling the same. More particularly, it relates to a battery system mounted in an electric vehicle and configured for being multi-charged, and a method of controlling the same during charging.

### Description of Related Art

An electric vehicle utilizes a battery as a power source and utilizes a motor operated by battery power to generate driving force for the vehicle. In the electric vehicle, the motor for driving the vehicle operates as a motor when power is supplied from the battery.

Furthermore, the motor for driving the vehicle is connected to a wheel to transmit power, and thus may operate as a generator by receiving rotation force of the wheel during braking or coasting of the vehicle, and may convert kinetic energy of the vehicle into electrical energy, which is regenerative energy, and store the energy in the battery while operating as a generator.

In general, a pack-type battery, that is, a battery pack, is used in the electric vehicle, and a battery system of the electric vehicle includes the aforementioned battery pack and accessory devices.

A battery pack for an electric vehicle includes a plurality of battery modules, typically 25 or more modules are connected in series, and each module includes a plurality of cells.

Furthermore, the battery system includes a sensor for detecting battery state information such as voltage, current, and temperature of a cell included in the battery module, and a battery management system (BMS) for collecting real-time battery state information detected by the sensor and controlling an operation of the cell.

Furthermore, the battery system has a configuration to prevent fire by blowing a fuse or operating a relay connected to an inverter when an internal short circuit occurs or an overcurrent flows in the battery pack.

Meanwhile, when it is difficult to ensure stable driving to a destination due to a low state of charge (SOC) value of the battery after the end of operation of the vehicle or during operation, the battery needs to be charged using utility power.

An eco-friendly vehicle such as a battery electric vehicle (BEV) or a plug-in hybrid electric vehicle (PHEV) may use electric vehicle supply equipment (EVSE) provided at a charging station to charge a battery.

For example, an 800 V-class high-voltage battery system may be mounted in an electric vehicle, and external chargers of various specifications may be used to charge a battery of such an electric vehicle. A super-fast charger (800 V-class charging compatible) may be used as an external charger connected to the vehicle during charging, or a general electric vehicle charger (400 V-class) infrastructure may be used for rapid or slow charging.

Furthermore, a multi-charging method for charging using a motor-inverter (power converter) is applied to a typical electric vehicle provided with the high-voltage battery system so that both the super-fast charger and the general charger may be used.

A multi-charging system utilizes an inverter connected to a motor as a power converter to boost output (charger supply voltage) of an external charger, and then charges a battery. For example, the multi-charging system may be a system configured for charging an 800 V-class vehicle battery using an about 400 V-class external charger.

However, in such a multi-charging system, because the battery is charged by boosting of the charging voltage, charging efficiency is poor. Furthermore, there is a high possibility of causing quality problems such as deterioration of durability of the motor and inverter used during charging.

Furthermore, the current multi-charging system charges the battery through a multi-charging circuit even when an 800 V-class battery is charged with an 800 V-class charger, thus limiting a charging speed.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery system of an electric vehicle and a method of controlling the same during charging configured for solving a problem of a conventional multi-charging system, preventing deterioration of charging efficiency or deterioration of motor-inverter durability due to voltage increase, and charging a battery at high speed.

Various aspects of the present disclosure are directed to providing a battery system of an electric vehicle, the battery system including a first group module configured by connecting a plurality of battery modules in series, a second group module configured by connecting a plurality of battery modules in series, a voltage switching circuit unit disposed between the first group module and the second group module to selectively switch between a series connection and a parallel connection of the first module group and the second module group; and a controller configured to control an operation of the voltage switching circuit unit based on a charger supply voltage or an available voltage according to charger specifications, which is determined by a charger connected to the vehicle, and a current battery voltage or an output voltage of a battery pack including the first module group and the second module group when a battery of the vehicle is charged

Various aspects of the present disclosure are directed to providing a method of controlling, during charging, a battery system of an electric vehicle including a first group module configured by connecting a plurality of battery modules in series, a second group module configured by connecting a plurality of battery modules in series, a voltage switching circuit unit configured between the first group module and the second group module to switch and vary a circuit connection state between the first group module and the second group module between a series connection state and a parallel connection state, the method including receiving, by a controller, a charger supply voltage, which is a suppliable voltage according to charger specifications, as information of a charger connected to the vehicle when the charger is connected to the vehicle to charge the battery, obtaining, by the controller, a current battery voltage, which is a voltage of a battery pack including the first group module and the second group module, as battery state information, determining, by the controller, a circuit connection state during charging from among a series connection state and a parallel connection state based on the information of the charger and the battery state information, controlling, by the controller, an operation of the voltage switching circuit unit so that the circuit connection state becomes the determined circuit connection state, and performing, by the controller, a control operation for battery charging.

Other aspects and exemplary embodiments of the present disclosure are discussed infra.

The above and other features of the present disclosure are discussed infra.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram schematically illustrating a circuit connection state between battery modules when a first voltage charger is connected in a battery system according to various exemplary embodiments of the present disclosure;

FIG. 2 is a diagram schematically illustrating a circuit connection state between battery modules when a second voltage charger is connected in the battery system according to various exemplary embodiments of the present disclosure;

FIG. 3 is a block diagram illustrating a main configuration of the battery system according to various exemplary embodiments of the present disclosure;

FIG. 4 is a circuit schematic diagram illustrating the battery system according to various exemplary embodiments of the present disclosure; and

FIG. 5 is a flowchart illustrating a method of controlling the battery system during charging according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Specific structural or functional descriptions presented in the exemplary embodiments of the present disclosure are only illustrative for describing embodiments according to the concept of the present disclosure, and the exemplary embodiments according to the concept of the present disclosure may be implemented in various forms. Furthermore, the present disclosure should not be construed as being limited to the exemplary embodiments described herein, and should be understood to include all modifications, equivalents, and substitutes included in the spirit and scope of the present disclosure.

Meanwhile, in an exemplary embodiment of the present disclosure, even though terms such as “first,” “second,” etc. may be used to describe various elements, the elements are not limited by these terms. These terms are only used to distinguish one element from another. For example, within the scope not departing from the scope of rights according to the concept of the present disclosure, a first element may be referred to as a second element, and similarly, the second element may be referred to as the first element.

When an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween. Other expressions for describing a relationship between elements, that is, expressions such as “between” and “immediately between” or “adjacent to” and “directly adjacent to,” should be interpreted similarly.

Like reference numerals refer to like elements throughout. The terminology used herein is for describing the embodiments, and is not intended to limit the present disclosure. In the present specification, a singular expression includes the plural form unless the context clearly dictates otherwise. Referring to expressions “comprises” and/or “comprising” used in the specification, a mentioned component, step, operation, and/or element does not exclude the presence or addition of one or more other components, steps, operations, and/or elements.

Hereinafter, embodiments of the present disclosure will be described in detail with reference to the accompanying drawings.

Recent electric vehicles are each provided with an 800 V-class battery system for super-fast charging. Furthermore, a 400 V-class external charger is applied to most charging infrastructure. To charge a battery of a vehicle provided with the 800 V-class battery system using such a 400 V-class external charger, it is necessary to boost the charging voltage.

A conventional multi-charging system utilizes an inverter connected to a motor as a power converter to boost a supply voltage of a 400 V-class external charger, so that an 800 V-class vehicle battery may be charged.

However, in such a multi-charging system, because the battery is charged by boosting of the charging voltage as described above, charging efficiency is poor. When an 800 V-class external charger-800 V-class battery is charged, a multi-charging circuit including a motor-inverter is used for charging, and thus charging speed is limited.

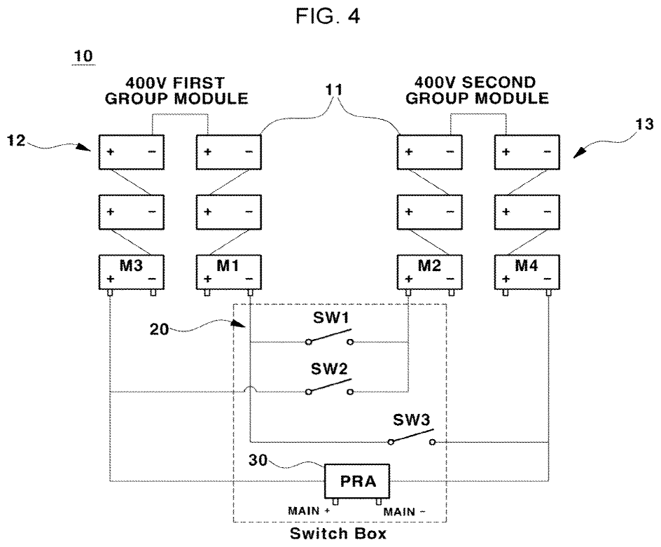

To solve the present problem, a battery system of an electric vehicle according to an exemplary embodiment of the present disclosure includes a voltage switching circuit unit (reference numeral “20” in FIG. 4) configured for switching and varying a voltage of the battery system according to a charger supply voltage.

That is, when a 400 V-class external charger is used, charging is performed by voltage switching (change in circuit connection state) of the battery system, rather than charging by boosting the charger supply voltage, using the voltage switching circuit unit.

To charge a battery of a vehicle provided with an 800 V-class battery system using a 400 V-class external charger applied to most charging infrastructure, it is conventionally necessary to boost the charging voltage using the multi-charging circuit.

However, the voltage switching circuit unit applied to the present disclosure changes the voltage of the battery system by changing a circuit connection state between high-voltage battery modules when a 400 V-class charger-800 V-class battery is connected, so that charging is possible without boosting the voltage of the multi-charging circuit.

Hereinafter, 400 V will be referred to as a “first voltage” and 800 V will be referred to as a “second voltage” for clear description of the present disclosure. Furthermore, a 400 V-class external charger of an ESEV for charging the electric vehicle will be referred to as a “first voltage charger,” and an 800 V-class external charger will be referred to as a “second voltage charger.”

Considering that the 800 V-class battery system is provided in a recent electric vehicle for super-fast charging, and a 400 V-class external charger is applied to most charging infrastructure, 400 V and 800 V are only referred to as the first voltage and the second voltage for convenience of description. In an exemplary embodiment of the present disclosure, the first voltage and the second voltage are not limited to 400 V and 800 V, respectively, and the meaning of the voltages of the first voltage and the second voltage may be variously changed as needed.

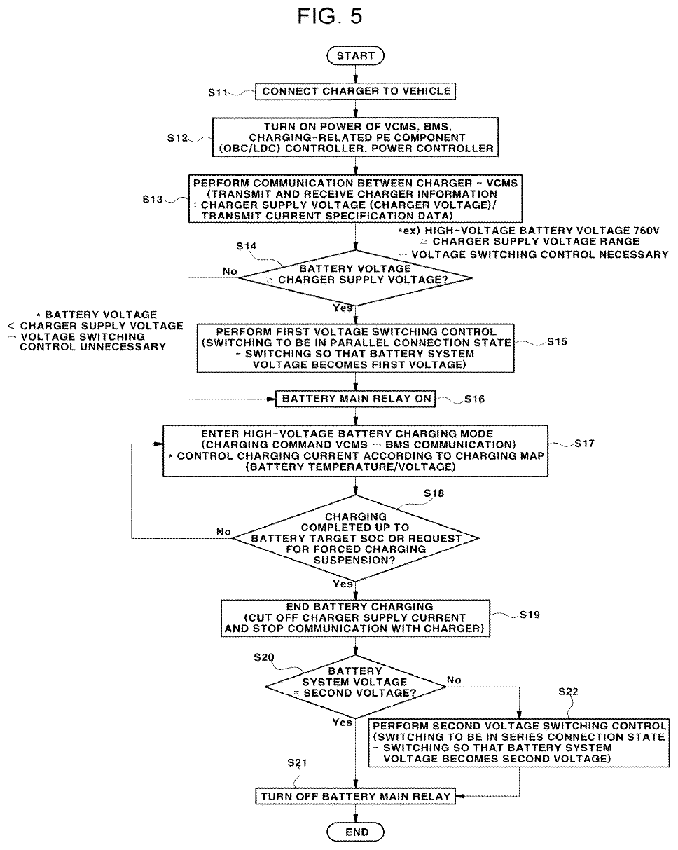

In an exemplary embodiment of the present disclosure, the first voltage and the second voltage may indicate charger specifications of charging equipment, and may mean suppliable voltages of the charger according to the specifications (“charger supply voltages” in FIG. 5). In an exemplary embodiment of the present disclosure, the first voltage is defined as a voltage lower than the second voltage.

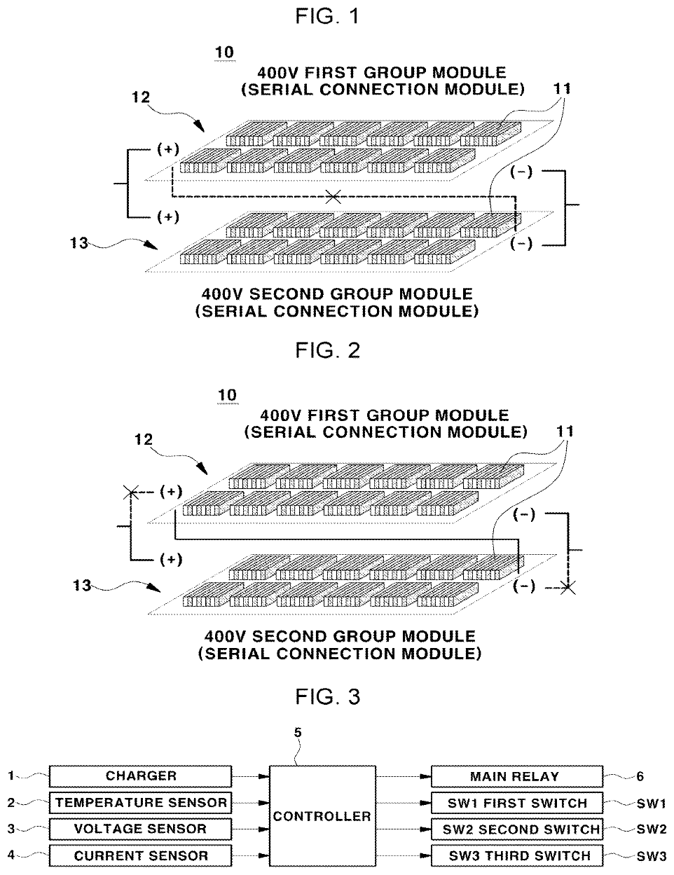

FIG. 1 and FIG. 2 are diagrams illustrating a voltage switching method according to a charger supply voltage in a battery system 10 according to various exemplary embodiments of the present disclosure. In detail, FIG. 1 is a diagram schematically illustrating a circuit connection state between battery modules 11 when a first voltage charger is connected in the battery system according to various exemplary embodiments of the present disclosure, and FIG. 2 is a diagram schematically illustrating a circuit connection state between battery modules 11 when a second voltage charger is connected in the battery system according to various exemplary embodiments of the present disclosure.

As illustrated in FIG. 1 and FIG. 2, a battery pack 10 includes a plurality of (N+M) battery modules 11. Furthermore, although not shown in detail in the drawings, each battery module 11 may include a plurality of battery cells connected in series.

Furthermore, a plurality of (N) some modules among all the battery modules 11 are connected in series with each other, and a plurality of (M) remaining modules among all the battery modules 11 are connected in series with each other (N and M being natural numbers, which may be the same or different).

In the present way, all the battery modules 11 may be divided into two groups of modules, and at the instant time, modules forming one group are electrically connected to an external circuit or an external device in series.

In the following description, one of the two groups of battery modules will be referred to as a “first group module,” and the other one of the two groups will be referred to as a “second group module.”

Referring to various exemplary embodiments of FIG. 1 and FIG. 2, all the battery modules 11 are disposed in two rows of an upper layer and a lower layer, and in the instant case, a first group module 12 includes battery modules 11 in a first row, which is the upper layer, and a second group module 13 includes battery modules 11 in a second row, which is the lower layer.

Furthermore, among all the battery modules 11, all the battery modules forming the first group module 12 are connected in series, and all the battery modules forming the second group modules 13 are connected in series.

Furthermore, FIG. 1 illustrates the circuit connection state between the battery modules 11 when the first voltage charger (that is, 400 V-class rapid charger) is connected to the vehicle to charge the battery of the vehicle, and FIG. 2 illustrates the circuit connection state between the battery modules 11 when the second voltage charger (that is, 800 V-class super-fast charger) is connected to the vehicle to charge the battery of the vehicle.

The circuit connection state between the battery modules 11 is as illustrated in FIG. 1 when the vehicle is driving or during charging at slow speed or fast speed (˜ 150 kW), and the circuit connection state between the battery modules 11 is as illustrated in FIG. 2 during super-fast charging (800 V-350 KW).

Meanwhile, when a charger is connected to the vehicle to charge the battery, a controller performing battery charging control receives and confirms information of the charger connected to the vehicle, and obtains and checks a current battery voltage, which is battery state information. When a charger supply voltage is less than or equal to a current battery voltage, it is determined that the first voltage charger is connected to the vehicle. In the present instance, because it may not be possible to charge the battery, a control operation for lowering the battery voltage, that is, a switching control operation for changing a circuit connection state between the first group module 12 and the second group module 13 is performed.

That is, the operation of the voltage switching circuit unit is controlled to connect the first group module 12 and the second group module 13 in parallel to each other (voltage switching, steps S14 and S15 in FIG. 5 to be described later).

The first group module 12 is configured by connecting the plurality of (N) battery modules 11 in series. In the present instance, a voltage of the first group module 12, which is a series-connected module, is 400 V, and the second group module 13 is configured by connecting the plurality of (M) battery modules 11 in series. At the instant time, when a voltage of the second group module 13, which is a series-connected module, is 400 V, the first group module 12 and the second group module 13 are connected in parallel, and thus an operating voltage of the entire battery becomes 400 V. At the instant time, because a suppliable voltage of the first voltage charger, for example, a suppliable voltage of the 400 V-class charger, may be greater than 400 V, the battery may be charged.

On the other hand, when the charger supply voltage is greater (higher) than the current battery voltage, the controller is configured to determine that the second voltage charger is connected to the vehicle. At the instant time, since the battery may be charged, voltage switching control for changing the circuit connection state between the first group module 12 and the second group module 13 is not performed.

When the first group module 12 and the second group module 13 are previously connected in series, voltage switching is unnecessary even at the instant time, and thus voltage switching control is not performed and a series connection state between the battery modules is continuously maintained.

For example, when the voltage of the first group module 12 in which the plurality of battery modules 11 is connected in series is 400 V, and the voltage of the second group module 13 in which the plurality of battery modules 11 is connected in series is 400 V, the first group module and the second group module 13 are connected in series, and thus the operating voltage of the entire battery becomes 800 V. In the instant case, the 800 V-class charger may make the suppliable voltage higher than 800 V so that it is possible to charge an 800 V-class high-voltage battery. Thus, the battery may be charged.

However, when the charger supply voltage is greater (higher) than the current battery voltage, if the circuit connection state of the first group module and the second group module 13 is a parallel connection state, the controller is configured to perform switching control for changing the circuit connection state between the first group module 12 and the second group module 13 into a series connection state.

FIG. 3 is a block diagram illustrating a main configuration of the battery system according to various exemplary embodiments of the present disclosure. In various exemplary embodiments of the present disclosure, a controller 5 may receive information of the charger through communication with a charger 1 currently connected to the vehicle, and recognize the charger supply voltage (suppliable voltage according to the charger specifications) from the information of the charger received through communication with the charger 1. Here, the information of the charger may include a suppliable voltage, a current, etc. according to the specifications of the charger as charger specification information.

As described above, the controller 5 is a controller provided in the vehicle to communicate with the charger 1 connected to the vehicle when the battery is charged, and receives charger information including a suppliable voltage (charger supply voltage) from the charger connected to the vehicle.

The controller 5 may be a conventional vehicle charging management system (VCMS) provided separately from a conventional BMS, which is a battery controller, and performs cooperative control with the BMS to charge the battery.

Furthermore, in an exemplary embodiment of the present disclosure, the voltage switching circuit unit (reference numeral “20” in FIG. 4) is configured to mechanically switch the circuit connection state between the first group module 12 and the second group module 13 between a parallel state and a series state. In various exemplary embodiments of the present disclosure, the first group module 12 and the second group module 13 may be provided to maintain a basic serial connection state in normal times. That is, a basic circuit connection state of the first group module 12 and the second group module 13 may be a series connection state.

However, when the battery is charged by connecting the external charger 1 to the vehicle, the circuit connection state of the first group module 12 and the second group module 13 is switched to the parallel connection state during charging according to the charger supply voltage. Thereafter, when battery charging is completed or suspended, the circuit connection state may be restored to the series connection state, which is the basic circuit connection state.

In the present way, the circuit connection state between the first group module 12 and the second group module 13 is switched to the parallel connection state and then restored to the series connection state, which is the basic circuit connection state, by the controller 5 controlling the operation of the voltage switching circuit unit including a first switch SW1, a second switch SW2, and a third switch SW3.

That is, while the operation of the voltage switching circuit unit is controlled according to a control signal output by the controller 5, the circuit connection state between the first group module 12 and the second group module 13 is switched between the series connection state and the parallel connection state depending on the state of the controlled voltage switching circuit unit.

FIG. 4 is a circuit schematic diagram illustrating a battery system according to various exemplary embodiments of the present disclosure, in which a configuration of a voltage switching circuit unit 20 is illustrated. Furthermore, a power relay assembly (PRA) 30 including a main relay (reference numeral “6” in FIG. 3) is illustrated.

As illustrated in the figure, the battery system according to various exemplary embodiments of the present disclosure includes the voltage switching circuit unit 20 for switching and varying the circuit connection state between the first group module 12 and the second group module 13 to the series connection state or the parallel connection state, and a PRA 30 for selectively connecting and disconnecting the battery pack 10 to or from the external device.

The voltage switching circuit unit 20 and the PRA 30 may be provided in one switch box in the battery system. The PRA 30 includes a main relay 6 that power-connects or disconnects the battery pack 10 to or from an external device such as an inverter, and the battery pack 10 may be electrically connected to or disconnected from an electric load in the vehicle or the external charger 1 depending on the on or off state of the main relay 6.

Such a PRA is a known component previously used in the battery system, and a configuration, function, and operating state of a power assembly module are all known technical matters. Thus, further detailed description of a power assembly will be omitted herein.

The operations of both the voltage switching circuit unit 20 and the PRA 30 are controlled by the controller 5. Here, the controller 5 may be a VCMS as described above.

The voltage switching circuit unit 20 connects the first group module 12 and the second group module 13 in series or in parallel with each other according to a control signal output by the controller 5. In an exemplary embodiment of the present disclosure, each of the first group module 12 and the second group module 13 is configured by connecting series connection modules, that is, the plurality of battery modules 11, in series, as described above. However, the circuit connection state between the first group module 12 and the second group module 13 becomes a series connection state or a parallel connection state depending on the operating state of the voltage switching circuit unit 20.

In an exemplary embodiment of the present disclosure, the series connection state means a state in which the first group module 12 and the second group module 13 are electrically connected in series with respect to an external device connected through the PRA 30. Similarly, the parallel connection state means a state in which the first group module 12 and the second group module 13 are electrically connected in parallel with respect to the external device.

Here, the external device may be an electric load receiving power from the battery pack 10 in the vehicle, and in the instant case, the electric load may be an inverter for driving and controlling the motor. Furthermore, during charging, the external device becomes the external charger 1.

In the following description, the voltage of the battery pack, the battery voltage, and the voltage of the battery system may all have the same meaning. Furthermore, as in the exemplary embodiment of FIG. 1 and FIG. 2, assuming that the that the first group module 12 and the second group module 13 are configured by connecting the plurality of battery modules 11 in series, and are series-connected modules in which voltages at both ends of the first group module 12 and the second group module 13 are each 400 V, the battery pack voltage is 800 V when the first group module 12 and the second group module 13 are connected in series, and the battery pack voltage is 400 V when the first group module 12 and the second group module 13 are connected in parallel.

Meanwhile, as illustrated in FIG. 4, the voltage switching circuit unit 20 may include a plurality of switches SW1, SW2, and SW3 provided to open or close circuits on a connection circuit between the first group module 12 and the second group module 13. In the present instance, opening/closing operations of the plurality of switches SW1, SW2, and SW3 are controlled according to a control signal output by the controller 5, and may be, for example, all relay switches.

The voltage switching circuit unit 20 includes the first switch SW1 provided on a connection circuit connecting between a negative electrode (−) of a battery module M1 connected to one end of the first group module 12 and a positive electrode (+) of a battery module M2 connected to one end of the second group module, the second switch SW2 provided on a connection circuit connecting between a positive electrode (+) of a battery module M3 connected to the other end of the first group module 12 and the positive electrode (+) of the battery module M2 connected to the one end of the second group module 13, and the third switch SW3 provided on a connection circuit connecting between the negative electrode (−) of the battery module M1 connected to the one end of the first group module 12 and a negative electrode (−) of a battery module M4 connected to the other end of the second group module 13.

In the present instance, the PRA 30 is provided on a circuit connected to each of the positive electrode (+) of the battery module M3 connected to the other end of the first group module 12 and the negative electrode (−) of the battery module M4 connected to the other end of the second group module 13.

Table 1 below shows an to open or close state of each switch for performing a control operation to have a series connection state in which the first group module 12 and the second group module 13 are connected in series, and a parallel connection state in which the first group module 12 and the second group module 13 are connected in parallel.

In Table 1 below, the to open or close state of each switch is controlled by the controller VCMS 5. In Table 1 below, first voltage switching control means controlling operations of the first switch SW1, the second switch SW2, and the third switch SW3 of the voltage switching circuit unit 20 so that the first group module 12 and the second group module 13 are in the parallel connection state.

Furthermore, in Table 2 below, second voltage switching control means controlling operations of the first switch SW1, the second switch SW2, and the third switch SW3 of the voltage switching circuit unit 20 so that the first group module 12 and the second group module 13 are again in the series connection state, which is the basic circuit connection state.

TABLE 1

| | | Division | |
|---|---|---|---|
| | | 800 V charger | 400 V charger |
| | | (Super-fast charging) | (Rapid/slow charging) |
| | | Perform control operation | Perform control operation |
| | | to be in series connection | to be in parallel connection |
| | | state (second voltage | state (first voltage |
| | | switching control) | switching control) |
| Switch | SW1 | Close | Open |
| | SW2 | Open | Close |
| | SW3 | Open | Close |

Note
* Implement connection structure of PRA and three switches in one switch box, simplify battery system, and increase system energy density

During first voltage switching control for performing a control operation so that the first group module 12 and the second group module 13 are in the parallel connection state, the controller VCMS 5 opens the first switch SW1 and closes the second switch SW2 and the third switch SW3. At the instant time, the battery system voltage (battery voltage) becomes the first voltage (400 V).

As shown in Table 1, when the 400 V-class charger 1 is connected to the vehicle, and the charger supply voltage (which may be higher than the first voltage) is lower than the battery voltage in the second voltage (800 V) state, the controller 5 implements the first voltage switching control to switch the circuit connection state of the first group module 12 and the second group module 13 to the parallel connection state.

When the first group module 12 and the second group module 13 are in the series connection state, which is the basic circuit connection state, and the 800 V-class charger 1 is connected to the vehicle, the controller 5 maintains the circuit connection state between the first group module 12 and the second group module 13 as it is in the series connection state, which is the basic circuit connection state.

Accordingly, during second voltage switching control for performing a control operation so that the first group module 12 and the second group module 13 are again in the series connection state, which is the basic circuit connection state after the first group module 12 and the second group module 13 are put in the parallel connection state by the first voltage switching control, the controller VCMS 5 closes the first switch SW1 and opens the second switch SW2 and the third switch SW3. At the instant time, the battery system voltage (battery voltage) becomes the second voltage (400 V) again.

After battery charging starts with the charger 1 connected to the vehicle, when the battery state of charge (hereinafter referred to as “battery SOC”) reaches a target SOC and charging is completed, or there is a request for forced charging suspension, battery charging ends. In the present instance, when the first group module 12 and the second group module 13 are in the parallel connection state, the second switching control is performed to restore the series connection state, which is the basic circuit connection state.

Hereinafter, a method of controlling the battery system during charging according to various exemplary embodiments of the present disclosure will be described in detail.

FIG. 5 is a flowchart illustrating the method of controlling the battery system during charging according to various exemplary embodiments of the present disclosure.

First, the charger 1 is connected to the electric vehicle for charging the battery (step S11), and power of the VCMS and the BMS is turned on (step S12). Furthermore, power of a charging-related Power Electric (PE) component (OBC/LDC) controller, a power controller, etc. is turned on as in a normal electric vehicle.

Accordingly, communication between the in-vehicle controller 5, that is, the VCMS and the charger 1 is performed, and at the instant time, the VCMS 5 receives charger information from the charger 1 (step S13). The charger information may be charger specification information, and may include a charger suppliable voltage (charger supply voltage and charging voltage) and current data according to the charger specifications.

Accordingly, the VCMS 5 determines a circuit connection state during charging based on the charger information and the battery state information, and is configured to control the operation of the voltage switching circuit unit so that the circuit connection state becomes the determined circuit connection state.

In more detail, the VCMS 5 compares the charger supply voltage confirmed from the charger information with a current battery voltage (step S14), and determines the circuit connection state during charging to be the parallel connection state when the current battery voltage is equal to or greater than the charger supply voltage.

Accordingly, the VCMS 5 performs the first voltage switching control for switching the circuit connection state between the first group module 12 and the second group module 13 to the determined parallel connection state (step S15).

That is, the controller 5 is configured to control the first switch SW1, the second switch SW2, and the third switch SW3 of the voltage switching circuit unit 20 so that the battery voltage (battery system voltage) may be switched to the first voltage, and the circuit connection state between the first group module 12 and the second group module 13 is switched to the parallel connection state through the control of each of the switches SW1, SW2, and SW3.

When the suppliable voltage of the charger 1 connected to the vehicle, that is, the charger supply voltage is greater (higher) than the battery voltage in step S14, the controller 5 maintains the circuit connection state between the first group module 12 and the second group modules as it is in the series connection state, which is the basic circuit connection state, without switching the circuit connection state and voltage switching.

Thereafter, the controller (VCMS or BMS) 5 turns on the main relay 6 (step S16), enters the battery charging mode so that the battery is charged, and performs battery charging control (step S17).

In the present instance, the VCMS and the BMS may communicate with each other to perform battery charging control, and charging current control according to a charging map may be performed similarly to normal battery charging.

To control the charging current according to the charging map, it is possible to use battery state information detected by the controller 5 using the sensor, that is, information such as a battery temperature detected by a temperature sensor 2, a battery voltage detected by a voltage sensor 3, and a battery current detected by a current sensor 4.

Table 2 below illustrates a battery charging map, and when controlling the charging current, the controller 5 may determine a charging current corresponding to the current battery temperature using the battery charging map as shown in Table 2 below, and perform battery charging control using the determined charging current as a command value.

TABLE 2

| | . . . | | | | | | . . . |
|---|---|---|---|---|---|---|---|
| | (Lower limit | | | Room | | | (Upper limit |
| Temperature | charging | | | temperature | | | charging |
| (° C.) | temperature) | A − 10 | A − 5 | (A) | A + 5 | A + 10 | temperature) |
| Charging | a | b | c | d | e | f | g |
| current (A) | | | | | | | |
| (or power | | | | | | | |
| (kW)) | | | | | | | |
| Cut-off | Y | | X | | | | Z |
| voltage (V) | | | | | | | |

The battery charge control may be performed by cooperative control between the VCMS and the BMS, and there is no difference in the present battery charge control compared to that performed in a conventional electric vehicle. Therefore, a description will be omitted herein.

Meanwhile, during battery charging, when the battery SOC reaches the target SOC or there is a request for forced charging suspension, the controller 5 ends battery charging (steps S18 and S19). At the instant time, the controller 5 cuts off the charger supply current and stops communication with the charger 1.

After ending battery charging as described above, the controller 5 verifies whether the current battery system voltage is in the second voltage state (step S20). That is, after checking the circuit connection state between the first group module 12 and the second group module 13, when the circuit connection state between the two modules is the series connection state, the main relay 6 is turned off (step S22).

However, when the current battery system voltage is in the first voltage state instead of the second voltage, that is, when the circuit connection state between the first group module 12 and the second group module 13 is the parallel connection state, the second voltage switching control is performed (step S21).

In the present instance, the controller 5 is configured to control the opening and closing operations of the first switch SW1, the second switch SW2 and the third switch SW3 of the voltage switching circuit unit 20 so that the circuit connection state between the first group module 12 and the second group module 13 may be restored to the series connection state, which is the basic circuit connection state, switching the battery system voltage from the first voltage to the second voltage.

Accordingly, when the circuit connection state between the first group module 12 and the second group module 13 is restored to the series connection state, which is the basic circuit connection state, the controller 5 turns off the main relay 6 (step S22). Accordingly, all of the control process during charging of the battery system according to an exemplary embodiment of the present disclosure ends.

Meanwhile, in another exemplary embodiment of the present disclosure, the voltage switching circuit unit 20 may be configured between the first group module 12 and the second group module 13 to selectively switch a circuit connection state between the first group module 12 and the second group module 13 such that the first group module 12 and the second group module 13 are electrically connected to or disconnected from each other.

The controller 5 controls the voltage switching circuit unit 20 to operate based on a charger supply voltage, which is obtained when a charger 1 is connected to the vehicle, and an operating voltage of a battery pack 10 including the first group module 12 and the second group module 13.

In response to determining that the charger supply voltage is less than or equal to the operating voltage of the battery pack 10, the controller 5 controls the voltage switching circuit unit 20 to electrically disconnect the first group module 12 from the second group module 13 for battery charging, and performs a control operation to sequentially charge the first group module 12 and the second group module 13.

Moreover, in response to determining that the charger supply voltage is less than or equal to the operating voltage of the battery pack 10, during the battery charging, the controller 5 opens the first switch SW1 and the second switch SW2 and closes the third switch SW3 to electrically disconnect the first group module 12 from the second group module 13, and then performs a control operation for charging the first group module, and after completing the charging of the first group module 12, the controller 5 opens the first switch SW1 and the third switch SW3 and closes the second switch SW2, and then performs a control operation for charging the second group module 13.

Furthermore, in response to determining that the charger supply voltage is higher than the operating voltage of the battery pack 10, the controller 5 controls the voltage switching circuit unit 20 to electrically connect the first group module 12 to the second group module 13 for the battery charging, and performs a control operation for simultaneously charging the first group module 12 and the second group module 13.

Here, the controller 5 closes the first switch SW1 and opens the second switch SW2 and the third switch SW3 to electrically connect the first group module 12 to the second group module 13, and then performs a control operation for simultaneously charging the first group module 12 and the second group module 13.

Accordingly, according to the battery system of the electric vehicle and the method of controlling the same during charging according to an exemplary embodiment of the present disclosure, it is possible to eliminate the conventional multi-charging circuit by use of the voltage switching circuit unit configured for varying the voltage of the battery system according to the charger supply voltage, and to connect and use a charger-battery direct charging circuit, facilitating faster super-fast charging even when an 800 V-class charger is used.

Furthermore, various problems of the existing multi-charging circuit, such as a decrease in charging efficiency and a decrease in durability of the motor and the inverter, may be solved.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery system of a vehicle, the battery system comprising:
a first battery group including a plurality of battery modules;
a second battery group including a plurality of battery modules;
a voltage switching circuit unit configured between the first battery group and the second battery group to selectively switch a circuit connection state between the first battery group and the second battery group such that the first battery group and the second battery group are electrically connected to or disconnected from each other; and
a controller configured to control the voltage switching circuit unit to operate based on a charger supply voltage, which is obtained when a charger is connected to the vehicle, and an operating voltage of a battery pack including the first battery group and the second battery group,
wherein
in response to determining that the charger supply voltage is less than or equal to the operating voltage of the battery pack,
the controller controls the voltage switching circuit unit to electrically disconnect the first battery group from the second battery group for battery charging, and performs a control operation to charge the first battery group and the second battery group.

2. The battery system of claim 1, wherein the battery modules included in each of the first battery group and the second battery group are connected in series.

3. The battery system of claim 1, wherein the voltage switching circuit unit includes:
a first switch provided between a negative electrode of a battery module connected to a first end of the first battery group and a positive electrode of a battery module connected to a first end of the second battery group;
a second switch provided between a positive electrode of a battery module connected to a second end of the first battery group and the positive electrode of the battery module connected to the first end of the second battery group; and
a third switch provided between the negative electrode of the battery module connected to the first end of the first battery group and a negative electrode of a battery module connected to a second end of the second battery group.

4. The battery system of claim 3, further including:
a power relay assembly configured to electrically connect or disconnect the battery pack including the first battery group and the second battery group to or from an external device,
wherein the power relay assembly is provided on a circuit connected to the positive electrode of the battery module connected to the second end of the first battery group and the negative electrode of the battery module connected to the second end of the second battery group.

5. The battery system of claim 3, wherein
in response to determining that the charger supply voltage is less than or equal to the operating voltage of the battery pack, during the battery charging,
the controller opens the first switch and the second switch and closes the third switch to electrically disconnect the first battery group from the second battery group, and then performs a control operation for charging the first battery group, and
after completing the charging of the first battery group, the controller opens the third switch and closes the second switch, and then performs a control operation for charging the second battery group.

6. The battery system of claim 3, wherein
in response to determining that the charger supply voltage is higher than the operating voltage of the battery pack,
the controller controls the voltage switching circuit unit to electrically connect the first battery group to the second battery group for the battery charging, and performs a control operation for simultaneously charging the first battery group and the second battery group.

7. The battery system of claim 6, wherein the controller closes the first switch and opens the second switch and the third switch to electrically connect the first battery group to the second battery group, and then performs a control operation for simultaneously charging the first battery group and the second battery group.

8. The battery system of claim 1, wherein
in response to determining that the charger supply voltage is higher than the operating voltage of the battery pack,
the controller controls the voltage switching circuit unit to electrically connect the first battery group to the second battery group for the battery charging, and performs a control operation for simultaneously charging the first battery group and the second battery group.

9. A method of controlling, during charging, a battery system of a vehicle including a first battery group including a plurality of battery modules, a second battery group including a plurality of battery modules, and a voltage switching circuit unit configured between the first battery group and the second battery group to selectively switch a circuit connection state between the first battery group and the second battery group such that the first battery group and the second battery group are electrically connected to or disconnected from each other, the method comprising:
receiving, by a controller, a charger supply voltage as information of a charger when the charger is connected to the vehicle;
obtaining, by the controller, an operating voltage of a battery pack including the first battery group and the second battery group, as battery state information;
in response to determining that the received charger supply voltage is less than or equal to the obtained operating voltage of the battery pack, controlling, by the controller, the voltage switching circuit unit to electrically disconnect the first battery group from the second battery group for battery charging; and
performing, by the controller, a control operation to charge the first battery group and the second battery group.

10. The method of claim 9, wherein the battery modules included in each of the first battery group and the second battery group are connected in series.

11. The method of claim 9, wherein the voltage switching circuit unit includes:
a first switch provided between a negative electrode of a battery module connected to a first end of the first battery group and a positive electrode of a battery module connected to a first end of the second battery group;
a second switch provided between a positive electrode of a battery module connected to a second end of the first battery group and the positive electrode of the battery module connected to the first end of the second battery group; and
a third switch provided between the negative electrode of the battery module connected to the first end of the first battery group and a negative electrode of a battery module connected to a second end of the second battery group.

12. The method of claim 11, further including:
a power relay assembly configured to electrically connect or disconnect the battery pack including the first battery group and the second battery group to or from an external device,
wherein the power relay assembly is provided on a circuit connected to the positive electrode of the battery module connected to the second end of the first battery group and the negative electrode of the battery module connected to the second end of the second battery group.

13. The method of claim 11, wherein
in response to determining that the charger supply voltage is less than or equal to the operating voltage of the battery pack, during the battery charging,
the controller opens the first switch and the second switch and closes the third switch to electrically disconnect the first battery group from the second battery group, and then performs a control operation for charging the first battery group, and
after completing the charging of the first battery group, the controller opens the third switch and closes the second switch, and then performs a control operation for charging the second battery group.

14. The method of claim 11, wherein
in response to determining that the charger supply voltage is higher than the operating voltage of the battery pack,
the controller controls the voltage switching circuit unit to electrically connect the first battery group to the second battery group for the battery charging, and performs a control operation for simultaneously charging the first battery group and the second battery group.

15. The method of claim 14, wherein the controller closes the first switch and opens the second switch and the third switch to electrically connect the first battery group to the second battery group, and then performs a control operation for simultaneously charging the first battery group and the second battery group.

16. The method of claim 9, wherein
in response to determining that the charger supply voltage is higher than the operating voltage of the battery pack,
the controller controls the voltage switching circuit unit to electrically connect the first battery group to the second battery group for the battery charging, and performs a control operation for simultaneously charging the first battery group and the second battery group.
